(19) United States
(12) Patent Application Publication
(10) Pub. No.: US 2021/0018883 A1
(43) Pub. Date: Jan. 21, 2021

(54) MOTOR SELECTION DEVICE AND MOTOR SELECTION METHOD

(71) Applicant: FANUC CORPORATION, Yamanashi (JP)

(72) Inventors: Kodai Akashi, Yamanashi-ken (JP); Hidetoshi Uematsu, Yamanashi-ken (JP)

(21) Appl. No.: 16/926,996

(22) Filed: Jul. 13, 2020

(30) Foreign Application Priority Data
Jul. 18, 2019 (JP) 2019132554

(51) Int. Cl. G05B 19/04; G05B 19/404

(52) U.S. Cl. CPC G05B 19/04; G05B 19/404

(57) ABSTRACT

A motor selection device is equipped with a speed calculation unit that calculates a motor selection speed from a speed waveform of a motor that drives a predetermined driven object, in consideration of iron loss generated in a target motor serving as an object to be selected, the speed waveform being obtained when the driven object is made to perform a prescribed operation, a storage unit that stores a motor characteristic corresponding to a speed of the target motor serving as the object to be selected, and a determination unit that determines whether or not the prescribed operation by the target motor is possible, using the motor characteristic corresponding to the motor selection speed.

### CROSS-REFERENCE TO RELATED APPLICATION

This application is based upon and claims the benefit of priority from Japanese Patent Application No. 2019-132554 filed on Jul. 18, 2019, the contents of which are incorporated herein by reference.

### BACKGROUND OF THE INVENTION

### Field of the Invention

The present invention relates to a motor selection device and a motor selection method for selecting an appropriate motor.

### Description of the Related Art

As disclosed in Japanese Laid-Open Patent Publication No. 2018-153045, in a conventional motor selection device, motor selection is performed by determining whether or not a root mean square torque during execution of an operation pattern is less than a continuous torque (rated torque) of the motor.

### SUMMARY OF THE INVENTION

In the case of being rotated at a high speed, iron loss is generated in the motor and generation of heat increases. Accordingly, if the motor is selected by determining that the root mean square torque is less than or equal to the continuous torque of the motor at a time when the rotation speed is low, the selection is made without taking into consideration generation of heat due to iron loss. When the motor which is selected in this manner is rotated at a high speed, there has been a problem in that overheating of the motor disadvantageously takes place. Stated otherwise, conventionally, the motor has been selected without taking into consideration generation of heat due to iron loss.

Thus, the present invention has the object of providing a motor selection device and a motor selection method, in which it is possible to select a motor in consideration of generation of iron loss.

A first aspect of the present invention is characterized by a motor selection device, comprising a speed calculation unit configured to calculate a motor selection speed from a speed waveform of a motor configured to drive a predetermined driven object, in consideration of iron loss generated in a target motor serving as an object to be selected, the speed waveform being obtained when the driven object is made to perform a prescribed operation, a storage unit configured to store a motor characteristic corresponding to a speed of the target motor serving as the object to be selected, and a determination unit configured to determine whether or not the prescribed operation by the target motor is possible, using the motor characteristic corresponding to the motor selection speed.

A second aspect of the present invention is characterized by a motor selection method for a motor selection device comprising a storage unit, the storage unit being configured to store a motor characteristic corresponding to a speed of a target motor serving as an object to be selected, the motor selection method comprising a speed calculation step of calculating a motor selection speed from a speed waveform of a motor configured to drive a predetermined driven object, in consideration of iron loss generated in the target motor serving as the object to be selected, the speed waveform being obtained when the driven object is made to perform a prescribed operation, and a determination step of determining whether or not the prescribed operation by the target motor is possible, using the motor characteristic corresponding to the motor selection speed.

According to the present invention, it is possible to select a motor in consideration of generation of iron loss.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a schematic configuration diagram of a motor selection device according to an embodiment;

FIG. 2 is a diagram showing an operation pattern of a driven object determined in accordance with operating conditions;

FIG. 3 is a diagram showing a speed waveform of the driven object obtained by way of a simulation;

FIG. 4 is a diagram showing a torque waveform of a motor obtained by way of a simulation;

FIG. 5 is a diagram showing a timewise change (speed waveform) in a speed of a motor;

FIG. 6 is a diagram showing a rated torque corresponding to a speed of a target motor;

FIG. 7 is a flowchart illustrating a motor selection method according to an embodiment; and

FIG. 8 is a schematic configuration diagram of a motor selection device according to a fourth modification.

### DESCRIPTION OF THE PREFERRED EMBODIMENTS

Preferred embodiments in relation to a motor selection device and a motor selection method according to the present invention will be presented and described in detail below with reference to the accompanying drawings.

### EMBODIMENTS

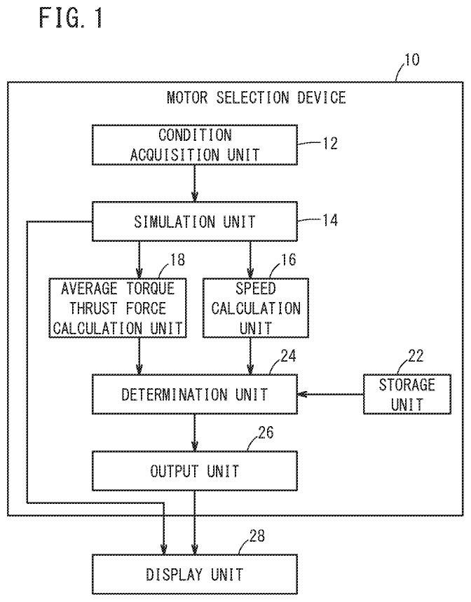

FIG. 1 is a schematic configuration diagram of a motor selection device 10 according to an embodiment of the present invention. The motor selection device 10 is a device that provides assistance in selecting a motor, by indicating to a user whether or not a motor serving as an object to be selected satisfies an ability required for the motor that drives a driven object when the driven object is made to perform a prescribed operation.

The motor selection device 10 is equipped with a condition acquisition unit 12, a simulation unit 14, a speed calculation unit 16, an average torque thrust force calculation unit 18, a storage unit 22, a determination unit 24, and an output unit 26. The motor selection device 10 includes a processor such as a CPU or the like and a memory, and functions as the motor selection device 10 of the present embodiment by executing a program stored in the memory. A display unit 28 is installed externally of the motor selection device 10, and the display unit 28 displays the output results from the simulation unit 14 and the output unit 26. It should be noted that the display unit 28 may also be provided as a portion of the motor selection device 10.

The condition acquisition unit 12 acquires a mechanical condition of a driven object (not shown) that is driven by a motor (not shown), and an operation condition indicating a prescribed operation pattern, the conditions being input by the user. The driven object is all driven members that are driven by the motor. A ball screw mechanism is disposed at a distal end of the motor, and due to rotary motion of the motor, a table on which a nut is installed is made to undergo linear movement. Accordingly, the driven members include a ball screw, the nut, the table, and a workpiece or the like that is mounted on the table. Further, in the following description, a rotation speed of the motor may be simply referred to as a speed.

The mechanical condition acquired by the condition acquisition unit 12 is a physical quantity related to the driven object, and includes parameters such as a length and a diameter of the ball screw, the masses of the table and the workpiece, and a coefficient of friction. The operation condition acquired by the condition acquisition unit 12 includes parameters that define a prescribed operation pattern, such as a movement distance, and a speed of movement of the table and the workpiece. Since the prescribed operation by the predetermined driven object is determined by the mechanical condition and the operation condition acquired by the condition acquisition unit 12, the condition acquisition unit 12 outputs the acquired mechanical condition and operation condition to the simulation unit 14.

The simulation unit 14 obtains, by way of a simulation, a speed waveform and a torque waveform of the motor that drives the predetermined driven object, when the driven object is made to perform the prescribed operation based on the mechanical condition and the operation condition input by the condition acquisition unit 12.

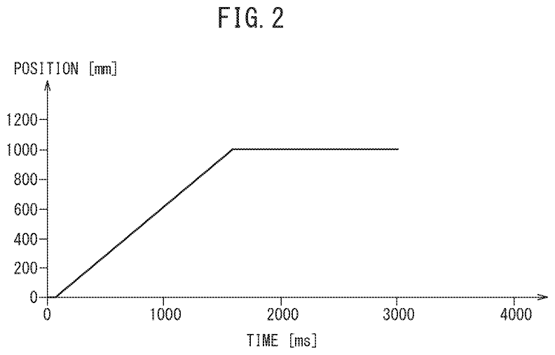

FIG. 2 is a diagram showing an operation pattern of the driven object determined in accordance with operating conditions. In FIG. 2, the horizontal axis represents time, and the vertical axis represents the position of the table (or the workpiece). In FIG. 2, an operation pattern is shown in which, during a predetermined time period, the table (or the workpiece) moves 1 m in a predetermined direction and comes to a stop.

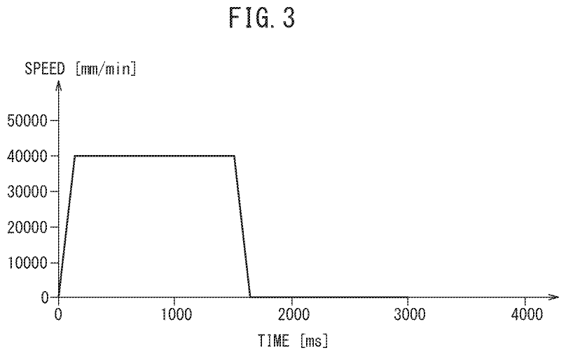

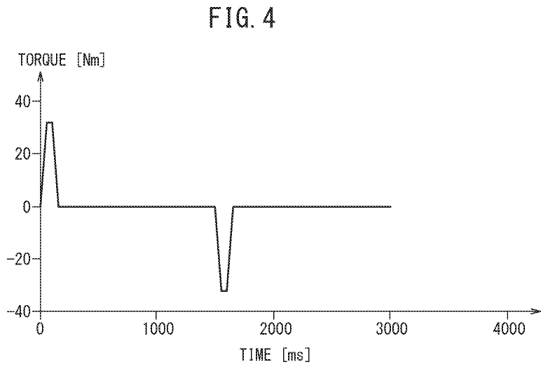

FIG. 3 is a diagram showing a speed waveform of the driven object obtained by way of a simulation. In FIG. 3, the horizontal axis represents time, and the vertical axis represents the speed of the table (or the workpiece). Accordingly, in FIG. 3, if the units of the vertical axis are changed, the speed waveform of the motor is obtained. FIG. 4 is a diagram showing a torque waveform of the motor obtained by way of a simulation. In FIG. 4, the horizontal axis represents time, and the vertical axis represents the torque of the motor. As shown in FIGS. 3 and 4, the simulation unit 14 determines a rotation speed waveform and a torque waveform of the motor in the case that the driven object is made to execute the operation shown in FIG. 2, and displays, on the display unit 28, the waveforms together with FIG. 2, which can be shown to the user.

The speed calculation unit 16 calculates a motor selection speed from the speed waveform of the motor obtained by way of the simulation of the simulation unit 14, and in consideration of iron loss generated in the target motor serving as the object to be selected. The speed calculation unit 16 outputs the calculated motor selection speed to the determination unit 24.

Hereinafter, a description will be given concerning a method whereby the speed calculation unit 16 calculates, on the basis of the speed waveform, the motor selection speed while taking into consideration iron loss generated in the target motor. First, the iron loss generated in the motor is expressed by the equation, iron loss=A×speed+B×(speed)², using a coefficient A and a coefficient B which are determined depending on the target motor.

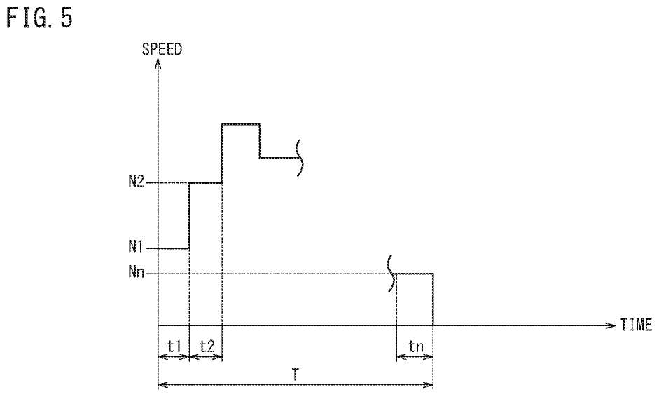

FIG. 5 is a diagram showing a timewise change (speed waveform) in the speed of the motor. The vertical axis represents the (rotational) speed of the motor, and the horizontal axis represents time. In FIG. 5, it is shown that the speed is maintained at N1 during the time period t1, the speed is maintained at N2 during the time period t2, . . . , and the speed is maintained at Nn during the time period tn. In addition, such a timewise change in speed is repeated in the form of a cycle over the time period T. In this instance, T=t1+t2+ . . . +tn. In such a case, the total amount X of heat generated due to iron loss in the target motor having the coefficient A and the coefficient B is expressed by the following equation (1).

X=A×(N1×t1+N2×t2+ . . . +Nn×tn)+B×(N1²×t1+N2²×t2+ . . . +Nn²×tn) (1)

In addition, the amount Y of heat generated per unit time is expressed by the following equation (2).

Y=A×(N1×t1+N2×t2+ . . . +Nn×tn)/T+B×(N1²×t1+N2²×t2+ . . . +Nn²×tn)/T (2)

In this instance, (N1×t1+N2×t2+ . . . +Nn×tn)/T is an average speed Nmean determined by executing an arithmetic mean calculation from the speed waveform, and (N1²×t1+N2²×t2+ . . . +Nn²×tn)/T is the square of a root mean square speed Nrms determined by executing a root mean square calculation from the speed waveform.

Accordingly, the amount Y of heat generated per unit time can be expressed by the following equation (3).

Y=A×Nmean+B×Nrms² (3)

In this instance, assuming that, while the speed of the motor is constant, a speed which produces an amount of heat generated per unit time that is equal to Y of equation (3) is given by a motor selection speed Ns, the following relationship is established.

A×Nmean+B×Nrms²=A×Ns+B×Ns² (4)

When equation (4) is solved for Ns and the positive solution thereof is selected, the value of Ns is given by the following equation (5).

Ns=(1/2)(−A/B+\sqrt{ }(A²/B²+4((A/B)×Nmean+Nrms²))) (5)

In the foregoing manner, the speed calculation unit 16 determines the motor selection speed Ns. By using equation (5), the motor selection speed can be determined with high accuracy while iron loss is taken into consideration.

The average torque thrust force calculation unit 18 calculates the root mean square torque from the torque waveform obtained by way of the simulation of the simulation unit 14, and outputs the root mean square torque to the determination unit 24.

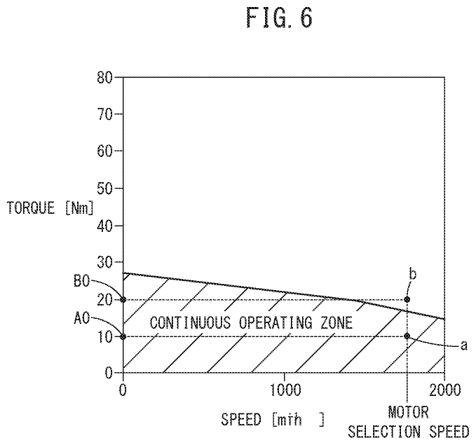

The storage unit 22 stores the motor characteristic corresponding to the speed of the target motor serving as the object to be selected. In this instance, the motor characteristic stored in the storage unit 22 is a rated torque. Accordingly, the storage unit 22 stores a relationship between a rated torque corresponding to a speed and each of a plurality of motors. FIG. 6 is a diagram showing a rated torque corresponding to the speed of the target motor. In FIG. 6, the vertical axis represents the torque, and the horizontal axis represents speed. Since the target motor is capable of being continuously operated at a torque of less than or equal to the rated torque at each of respective speeds, the zone of such a torque is shown as a continuous operating zone.

The determination unit 24, using the motor characteristic corresponding to the motor selection speed, determines whether or not the prescribed operation of the driven object by the target motor is possible. More specifically, the determination unit 24 compares the root mean square torque obtained from the average torque thrust force calculation unit 18, and the rated torque corresponding to the motor selection speed of the target motor obtained by accessing the storage unit 22. Then, the determination unit 24 determines whether or not the root mean square torque is less than or equal to the above-described rated torque. If the root mean square torque is less than or equal to the rated torque, the target motor can be used to cause the predetermined driven object to perform the prescribed operation. In this instance, the target motor which is the subject of such a comparison is a motor serving as an object to be selected, which is selected from among a plurality of motors for which the storage unit 22 stores relationships between the rated torques corresponding to the speeds and the motors.

For example, as shown in FIG. 6, if the value of the root mean square torque calculated by the average torque thrust force calculation unit 18 is AO, a point a at which the value of the root mean square torque becomes AO at the motor selection speed calculated by the speed calculation unit 16 is included in the continuous operating zone. In this case, the determination unit 24 determines that the root mean square torque is less than or equal to the rated torque, and that the prescribed operation of the driven object by the target motor is possible. Further, if the value of the root mean square torque calculated by the average torque thrust force calculation unit 18 is BO, a point b at which the value of the root mean square torque becomes BO at the motor selection speed calculated by the speed calculation unit 16 is not included in the continuous operating zone. In this case, since the root mean square torque is not less than or equal to the rated torque, the determination unit 24 determines that the prescribed operation of the driven object by the target motor is impossible. The determination unit 24 outputs the above-described determination result to the output unit 26.

The output unit 26 outputs a notification signal to provide a notification of the determination result from the determination unit 24. By the display unit 28 displaying the content of the notification signal output by the output unit 26, a notification is issued to the user as to whether or not the target motor can be used.

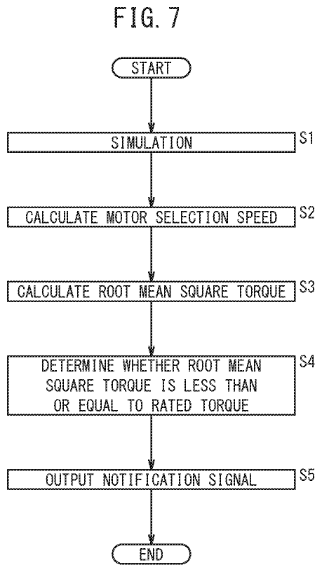

FIG. 7 is a flowchart illustrating a motor selection method according to the embodiment. Prior to the flowchart of FIG. 7 being started, the condition acquisition unit 12 outputs the acquired mechanical condition and operation condition to the simulation unit 14.

First, the simulation unit 14 simulates the speed waveform and the torque waveform of the motor that drives the predetermined driven object, when the driven object is made to perform the prescribed operation based on the mechanical condition and the operation condition input by the condition acquisition unit 12 (step S1).

Next, the speed calculation unit 16 calculates the motor selection speed from the speed waveform obtained in step S1, and outputs the motor selection speed to the determination unit 24 (step S2).

The average torque thrust force calculation unit 18 calculates the root mean square torque from the torque waveform obtained in step S1, and outputs the root mean square torque to the determination unit 24 (step S3).

The determination unit 24 compares the root mean square torque calculated by the average torque thrust force calculation unit 18, and the rated torque of the target motor corresponding to the motor selection speed determined by the speed calculation unit 16, and determines whether or not the root mean square torque is less than or equal to the rated torque (step S4). The determination unit 24 outputs, to the output unit 26, the determination result based on the determination made in step S4 and concerning whether or not the prescribed operation of the driven object by the target motor is possible.

The output unit 26 outputs the notification signal to provide the notification of the determination result of the determination unit 24 (step S5), and causes the content of the notification signal to be displayed on the display unit 28.

As has been described above, the motor selection device 10 of the present embodiment compares the root mean square torque, and the rated torque of the motor that serves as the object to be selected corresponding to the motor selection speed. By determining whether or not the root mean square torque is less than or equal to the rated torque, since a determination can be made as to whether or not the prescribed operation of the driven object by the target motor is possible, it becomes possible to select the motor in consideration of iron loss generated in the motor. As a result, it is possible to carry out the selection of the motor more appropriately than in the conventional technique.

### [Modifications]

The above-described embodiment may be modified in the following manner.

### (Modification 1)

In the above-described embodiment, the speed calculation unit 16 calculates the motor selection speed Ns using equation (5), while taking into consideration iron loss generated in the target motor. Since equation (5) is somewhat complicated, according to a first modification (Modification 1), the root mean square speed Nrms, which is determined by the speed calculation unit 16 executing the root mean square calculation from the speed waveform, is regarded as an approximate value of equation (5), and such a value is used as the motor selection speed. In accordance with this feature, while taking into consideration iron loss generated in the target motor, it is possible to determine the motor selection speed at a lower calculation cost.

### (Modification 2)

In the above-described embodiment, the speed calculation unit 16 calculates the motor selection speed Ns using equation (5), while taking into consideration iron loss generated in the target motor. Since equation (5) is somewhat complicated, according to a second modification (Modification 2), the average speed Nmean, which is determined by the speed calculation unit 16 executing the arithmetic mean calculation from the speed waveform, is regarded as an approximate value of equation (5), and such a value is used as the motor selection speed. In accordance with this feature, while taking into consideration iron loss generated in the target motor, it is possible to determine the motor selection speed at a lower calculation cost.

### (Modification 3)

In the above-described embodiment, the motor is assumed to be a rotating motor. However, according to a third modification (Modification 3), the motor is assumed to be a linear motor that does not undergo rotational movement. According to Modification 3, the simulation unit 14 obtains, by way of a simulation, the speed waveform and a thrust force waveform of the motor that drives the predetermined driven object, when the driven object is made to perform the prescribed operation based on the mechanical condition and the operation condition input by the condition acquisition unit 12.

In addition, the average torque thrust force calculation unit 18 calculates the root mean square thrust force from the thrust force waveform of the motor obtained by way of the simulation of the simulation unit 14, and outputs the root mean square thrust force to the determination unit 24. Further, the motor characteristic corresponding to the speed of the target motor that is stored in the storage unit 22 is a rated thrust force. The determination unit 24 compares the root mean square thrust force obtained from the average torque thrust force calculation unit 18, and the rated thrust force corresponding to the motor selection speed of the target motor obtained by accessing the storage unit 22.

Then, the determination unit 24 determines whether or not the root mean square thrust force is less than or equal to the above-described rated thrust force. If the root mean square thrust force is less than or equal to the rated thrust force, a determination is made that the target motor can be used to cause the predetermined driven object to perform the prescribed operation. In this manner, by taking into consideration iron loss, it becomes possible to select a linear motor more appropriately than in the conventional technique.

### (Modification 4)

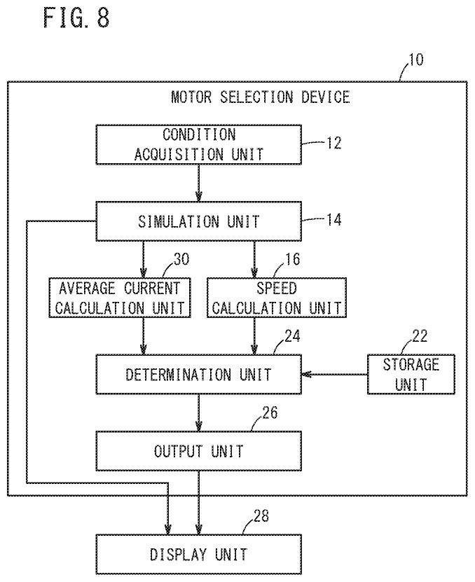

FIG. 8 is a schematic configuration diagram of a motor selection device 10 according to a fourth modification (Modification 4). In the motor selection device 10 shown in FIG. 8, the average torque thrust force calculation unit 18 of FIG. 1 is replaced by an average current calculation unit 30. According to Modification 4, the simulation unit 14 obtains, by way of a simulation, the speed waveform and a current waveform of the motor that drives the predetermined driven object, when the driven object is made to perform the prescribed operation based on the mechanical condition and the operation condition input by the condition acquisition unit 12.

In addition, the average current calculation unit 30 calculates the root mean square current from the current waveform of the motor obtained by way of the simulation of the simulation unit 14, and outputs the root mean square current to the determination unit 24. Further, the motor characteristic corresponding to the speed of the target motor that is stored in the storage unit 22 is a rated current. The determination unit 24 compares the root mean square current obtained from the average current calculation unit 30, and the rated current corresponding to the motor selection speed of the target motor obtained by accessing the storage unit 22.

Then, the determination unit 24 determines whether or not the root mean square current is less than or equal to the above-described rated current. If the root mean square current is less than or equal to the rated current, a determination can be made that the target motor can be used to cause the predetermined driven object to perform the prescribed operation. In accordance with this feature, also in the case that the current waveform of the motor is used, it becomes possible to select the motor more appropriately than in the conventional technique, by taking into consideration iron loss.

### (Modification 5)

In the above-described embodiment and Modifications 3 and 4, the speed waveform, the torque waveform, the thrust force waveform, and the current waveform of the motor are obtained by way of the simulation which is executed by the simulation unit 14. However, actually measured values that are acquired in advance may also be used. Based on such measured values, the speed calculation unit 16, the average torque thrust force calculation unit 18, or the average current calculation unit 30 may calculate the motor selection speed, the root mean square torque, the root mean square thrust force, or the root mean square current. Consequently, the simulation can be omitted.

### (Modification 6)

The above-described embodiment and the modifications thereof may be appropriately combined within a range in which no technical inconsistencies occur.

### Inventions that can be Obtained from the Embodiments

A description will be given below concerning the inventions that can be grasped from the above-described embodiments.

### (First Invention)

The motor selection device (10) is equipped with the speed calculation unit (16) that calculates the motor selection speed from the speed waveform of the motor that drives the predetermined driven object, in consideration of iron loss generated in the target motor serving as the object to be selected, the speed waveform being obtained when the driven object is made to perform a prescribed operation, the storage unit (22) that stores the motor characteristic corresponding to the speed of the target motor serving as the object to be selected, and the determination unit (24) that determines whether or not the prescribed operation by the target motor is possible, using the motor characteristic corresponding to the motor selection speed.

In accordance with such features, the motor can be selected in consideration of iron loss generated in the motor, and the motor can be selected more appropriately than in the conventional technique.

The motor selection device (10) may further be equipped with at least one of the average torque thrust force calculation unit (18) that calculates the root mean square torque or the root mean square thrust force from the torque waveform or the thrust force waveform of the motor that drives the driven object, and the average current calculation unit (30) that calculates the root mean square current from the current waveform of the motor, wherein the torque waveform, the thrust force waveform, and the current waveform are obtained when the driven object is made to perform the prescribed operation, and the output unit (26) that outputs the notification signal to provide a notification of the determination result of the determination unit (24). The motor characteristic may be the rated torque, the rated thrust force, or the rated current of the target motor, and the determination unit (24) may determine whether or not the root mean square torque, the root mean square thrust force, or the root mean square current is less than or equal to the rated torque, the rated thrust force, or the rated current of the target motor, respectively, corresponding to the motor selection speed.

The speed calculation unit (16) may calculate the motor selection speed using the relational expression Ns=(1/2)(−A/B+\sqrt{ }(A²/B²+4((A/B)×Nmean+Nrms²))), when the iron loss is expressed by the iron loss=A×speed+B x (speed)² using the coefficient A and the coefficient B, which are determined depending on the target motor, and when the average speed determined from the speed waveform is represented by Nmean, the root mean square speed determined from the speed waveform is represented by Nrms, and the motor selection speed is represented by Ns. In accordance with such features, the motor can be selected with high accuracy in consideration of iron loss generated in the motor.

The speed calculation unit (16) may calculate the motor selection speed by executing the root mean square calculation. In accordance with this feature, while taking into consideration iron loss generated in the target motor, it is possible to determine the motor selection speed at a lower calculation cost.

The speed calculation unit (16) may calculate the motor selection speed by executing the arithmetic mean calculation. In accordance with this feature, while taking into consideration iron loss generated in the target motor, it is possible to determine the motor selection speed at a lower calculation cost.

### (Second Invention)

Provided is a motor selection method for the motor selection device (10) that includes the storage unit (22), the storage unit (22) storing the motor characteristic corresponding to the speed of the target motor serving as the object to be selected, the motor selection method comprising the speed calculation step of calculating the motor selection speed from the speed waveform of the motor configured to drive the predetermined driven object, in consideration of iron loss generated in the target motor serving as the object to be selected, the speed waveform being obtained when the driven object is made to perform a prescribed operation, and the determination step of determining whether or not the prescribed operation by the target motor is possible, using the motor characteristic corresponding to the motor selection speed.

In accordance with such features, the motor can be selected in consideration of iron loss generated in the motor, and the motor can be selected more appropriately than in the conventional technique.

In the motor selection method, there may further be provided at least one of the average torque thrust force calculation step of calculating the root mean square torque or the root mean square thrust force from the torque waveform or the thrust force waveform of the motor that drives the driven object, and the average current calculation step of calculating the root mean square current from the current waveform of the motor, wherein the torque waveform, the thrust force waveform, and the current waveform are obtained when the driven object is made to perform the prescribed operation, and the outputting step of outputting the notification signal to provide the notification of the determination result of the determination unit. The motor characteristic may be the rated torque, the rated thrust force, or the rated current of the target motor, and in the determination step, it may be determined whether or not the root mean square torque, the root mean square thrust force, or the root mean square current is less than or equal to the rated torque, the rated thrust force, or the rated current of the target motor, respectively, corresponding to the motor selection speed.

In the speed calculation step, the motor selection speed may be calculated using the relational expression Ns=(1/2) (−A/B+\sqrt{ }(A²/B²+4((A/B)×Nmean+Nrms²))), when the iron loss is expressed by the iron loss=A×speed+B x (speed)² using the coefficient A and the coefficient B, which are determined depending on the target motor, and when the average speed determined from the speed waveform is represented by Nmean, the root mean square speed determined from the speed waveform is represented by Nrms, and the motor selection speed is represented by Ns. In accordance with such features, the motor can be selected with high accuracy in consideration of iron loss generated in the motor.

In the speed calculation step, the motor selection speed may be calculated by executing the root mean square calculation. In accordance with this feature, while taking into consideration iron loss generated in the target motor, it is possible to determine the motor selection speed at a lower calculation cost.

In the speed calculation step, the motor selection speed may be calculated by executing the arithmetic mean calculation. In accordance with this feature, while taking into consideration iron loss generated in the target motor, it is possible to determine the motor selection speed at a lower calculation cost.

What is claimed is:

1. A motor selection device, comprising:
a speed calculation unit configured to calculate a motor selection speed from a speed waveform of a motor configured to drive a predetermined driven object, in consideration of iron loss generated in a target motor serving as an object to be selected, the speed waveform being obtained when the driven object is made to perform a prescribed operation;
a storage unit configured to store a motor characteristic corresponding to a speed of the target motor serving as the object to be selected; and
a determination unit configured to determine whether or not the prescribed operation by the target motor is possible, using the motor characteristic corresponding to the motor selection speed.

2. The motor selection device according to claim 1, further comprising:
at least one of an average torque thrust force calculation unit configured to calculate a root mean square torque or a root mean square thrust force from a torque waveform or a thrust force waveform of the motor configured to drive the driven object, and an average current calculation unit configured to calculate a root mean square current from a current waveform of the motor, wherein the torque waveform, the thrust force waveform, and the current waveform are obtained when the driven object is made to perform the prescribed operation; and
an output unit configured to output a notification signal to provide a notification of a determination result of the determination unit,
wherein the motor characteristic is a rated torque, a rated thrust force, or a rated current of the target motor, and
the determination unit is configured to determine whether or not the root mean square torque, the root mean square thrust force, or the root mean square current is less than or equal to the rated torque, the rated thrust force, or the rated current of the target motor, respectively, corresponding to the motor selection speed.

3. The motor selection device according to claim 1, wherein the speed calculation unit is configured to calculate the motor selection speed using a relational expression
Ns=(1/2)(−A/B+\sqrt{ }(A²/B²+4((A/B)×Nmean+Nrms²)))
when the iron loss is expressed by the iron loss=A×speed+B×(speed)² using a coefficient A and a coefficient B, which are determined depending on the target motor, and when an average speed determined from the speed waveform is represented by Nmean, a root mean square speed determined from the speed waveform is represented by Nrms, and the motor selection speed is represented by Ns.

4. The motor selection device according to claim 1, wherein the speed calculation unit is configured to calculate the motor selection speed by executing a root mean square calculation.

5. The motor selection device according to claim 1, wherein the speed calculation unit is configured to calculate the motor selection speed by executing an arithmetic mean calculation.

6. A motor selection method for a motor selection device comprising a storage unit, the storage unit being configured to store a motor characteristic corresponding to a speed of a target motor serving as an object to be selected,
the motor selection method comprising:
a speed calculation step of calculating a motor selection speed from a speed waveform of a motor configured to drive a predetermined driven object, in consideration of iron loss generated in the target motor serving as the object to be selected, the speed waveform being obtained when the driven object is made to perform a prescribed operation; and
a determination step of determining whether or not the prescribed operation by the target motor is possible, using the motor characteristic corresponding to the motor selection speed.

7. The motor selection method according to claim 6, further comprising:
at least one of an average torque thrust force calculation step of calculating a root mean square torque or a root mean square thrust force from a torque waveform or a thrust force waveform of the motor configured to drive the driven object, and an average current calculation step of calculating a root mean square current from a current waveform of the motor, wherein the torque waveform, the thrust force waveform, and the current waveform are obtained when the driven object is made to perform the prescribed operation; and
an outputting step of outputting a notification signal to provide a notification of a determination result of the determination unit,
wherein the motor characteristic is a rated torque, a rated thrust force, or a rated current of the target motor, and
in the determination step, it is determined whether or not the root mean square torque, the root mean square thrust force, or the root mean square current is less than or equal to the rated torque, the rated thrust force, or the rated current of the target motor, respectively, corresponding to the motor selection speed.

8. The motor selection method according to claim 6, wherein, in the speed calculation step, the motor selection speed is calculated using a relational expression
Ns=(1/2)(−A/B+\sqrt{ }(A²/B²+4((A/B)×Nmean+Nrms²)))
when the iron loss is expressed by the iron loss=A×speed+B×(speed)² using a coefficient A and a coefficient B, which are determined depending on the target motor, and when an average speed determined from the speed waveform is represented by Nmean, a root mean square speed determined from the speed waveform is represented by Nrms, and the motor selection speed is represented by Ns.

9. The motor selection method according to claim 6, wherein, in the speed calculation step, the motor selection speed is calculated by executing a root mean square calculation.

10. The motor selection method according to claim 6, wherein, in the speed calculation step, the motor selection speed is calculated by executing an arithmetic mean calculation.
